(19) United States
(12) Patent Application Publication
(10) Pub. No.: US 2002/0096458 A1
(43) Pub. Date: Jul. 25, 2002

(54) System for filtering fluids, and the filter used in this system

(76) Inventor: Johannes Adrianus Thomassen, Blanes (ES)

Correspondence Address: STEINBERG & RASKIN, P.C., 1140 AVENUE OF THE AMERICAS, 15th FLOOR, NEW YORK, NY, 10036-5803, US

(21) Appl. No.: 09/934,023

(22) Filed: Aug. 21, 2001

(30) Foreign Application Priority Data
Jan. 19, 2001 (ES) P 200100172

(51) Int. Cl. B01D 63/00

(52) U.S. Cl. 210/134; 210/321.65; 210/321.72; 210/321.8

(57) ABSTRACT

A system for filtering fluids and the filter used in the system. This system comprises a plant formed by membrane filters and in which the fluid to be filtered is fed into the plant first with the flow in a given direction and then fed into the same plant with the flow in the opposite direction. The plant comprises valves which regulate the flow of the fluid supplied, and which mix the fluid flow supplied to the plant which is from different points of same. The filters of the plant are directly connected to each other without the need for external piping. The filter used in this system has a structure which allows flow reversal.

### FIELD OF THE INVENTION

System for filtering fluids, and the filter used in this system.

### BACKGROUND OF THE INVENTION

Plants for filtering fluids which use cylindrically shaped membrane filters, the fluids being generally liquid are already well known.

In these plants, the liquid passes from one filter to another until it exits via the last filter in the plant. This causes bacterial growth in the filters together with a gradual build up of deposits and impurities on the filter elements which can be rendered totally ineffective as this process is irreversible.

### BRIEF SUMMARY OF THE INVENTION

One of the purposes of this invention is precisely to remove this drawback in order to obtain a higher performance plant and to prolong the effective functionality of the filter elements.

To this purpose, one of the characteristics of the filtering system is that the fluid to be filtered is fed into the plant first flowing in a given direction and then the fluid is fed into the same plant in the opposite direction, thus avoiding the waste deposits described above on the filter elements of the final filters in this plant, thus prolonging the functional life of the filter membranes

Another characteristic of this invention is that this inversion of the fluids flow direction is complemented with a mix of flows. To this purpose, the plant is equipped with valves which regulate the flow of fluid supplied to the plant, and which serve also to mix the flow supplied to the plant from different entry points. This system offers a correct hydraulic balance as the flow rate and speed of the fluid in the different filters forming the plant is controlled in order to recover the maximum amount of dean liquid which is also of excellent quality.

Another of the characteristics of the system is that the plant filters are connected directly to each other, without the use of external piping, This simplifies the plant considerably while also reducing the cost to a large extent.

This direct connection between the filters is achieved using the end filterheads of the body of each filter.

Naturally, in order to achieve the inversion of the fluid direction and the direct connection between the filters, membrane filters are necessary which have a body suitable for this inversion in the liquid direction and the filterheads of these bodies must be prepared for the direct connections

In this system it is preferable to use membrane filters with body under UM 200002987 and with filterheads connected to the body of the filter, in accordance with UM 200002986 and 200100127, which filters have a structure which allows a reversible fluid flow

These and other characteristics are better displayed in the detailed description below, accompanied by two pages of drawings showing a practical case and which is mentioned as a practical example of the scope of this invention, though not limited to same:

### BRIEF DESCRIPTION OF THE DRAWINGS

FIGS. 1 and 2 show a diagram of the plants in a 4-2-1 formation and the re-circulation circuit respectively, in which this invention's system is used,

FIG. 3 shows a diagram of a plant using this system with mixing of the fluid flow, and

FIG. 4 shows the details of the filters and of its connections used in this system in a lengthwise section.

### DETAILED DESCRIPTION OF PREFERRED EMBODIMENTS

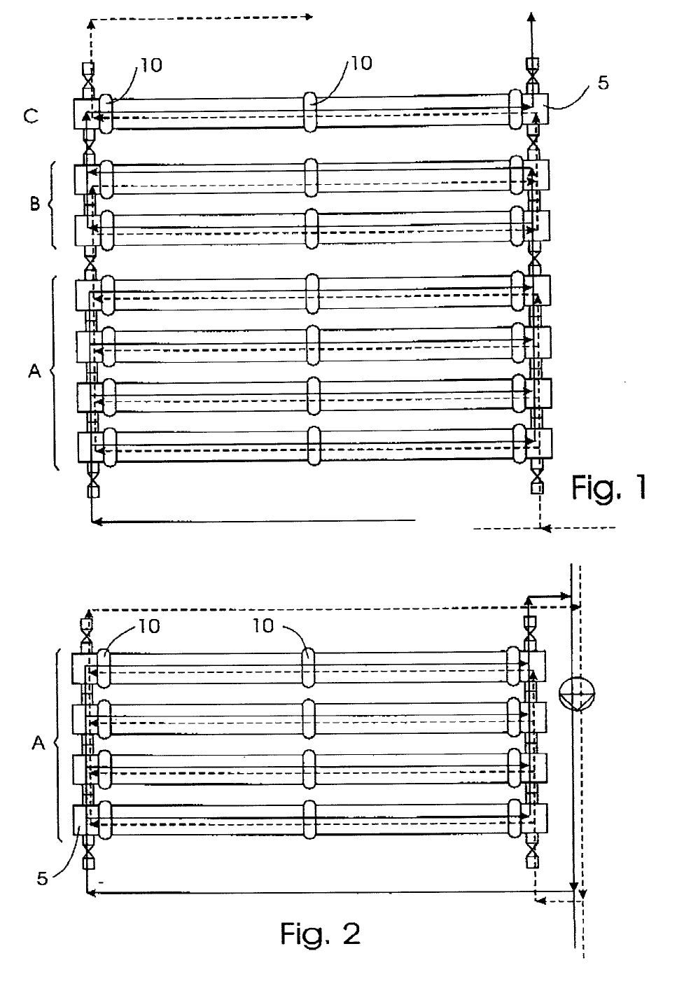

FIG. 1 shows a plant of the 4-2-1 type, known as a “Christmas Tree”, in which the system is used with reversal of the fluid direction under this invention. These 4-2-1 plants have a first filtering phase in which the fluid is fed to a group -A- of four membrane filters; in the second phase, the fluid is filtered in a group -B- of two filters and then the fluid is fed into a third phase formed by one -C- filter, while the path of the fluid is shown in broken lines and arrows.

According to this system, the fluid is then fed to the plant in the opposite direction, this new path being represented by broken lines and arrows.

FIG. 2 shows a plant of the recirculation circuit type (single or multi-phase). In this case the plant comprises a group -A- of four filters with the fluid passing through all of them, first flowing in the direction shown by the continuous lines and arrows and then the fluid passes again through the filters but with the flow reversed as shown by the broken lines and arrows.

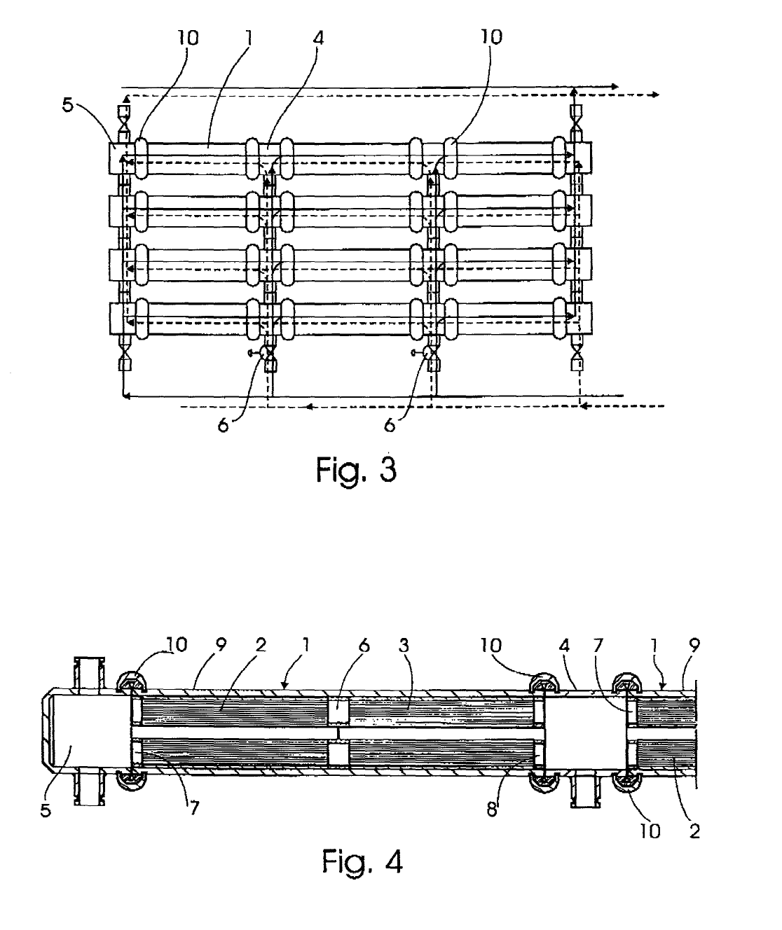

FIG. 3 shows a plant in which the fluid also passes first with the flow in one direction and then in the opposite direction, and also mixes the fluid flows. This plant comprises filters -1- consisting of two filter elements -2- and -3- (FIG. 4), connected by connector elements -4- and heads -5-, forming four rows of three filters each, with valves in the lower part -6-. This plant achieves complete flow balance within the membrane filtering system, as fluid can be introduced in a regulated fashion at several points of the plant.

As can be seen in FIGS. 1, 2 and 3, in the plants shown, the filters are connected to each other without the need for external piping.

In order to achieve the reversal of the fluid flow, filters should be used with a structure which allows such reversal.

FIG. 4 shows the filter and the connections used in the system which is the subject of this invention and which are filters under UM 200002987 and the heads and connecting elements under UM 200002986 and 200100127. These filers -1- comprise several filter elements -2-3- connected to each other coaxially with connection elements -6- to form an assembly which has end parts -7- and -8- at each end, with the entire assembly surrounded by a layer -9- molded over it from glass fiber and resin which after hardening, forms the rigid, cylindrical external surface of the membrane filter body. The heads -5- are connected to the filter bodies by a clamp -10- which has a U section creating two peripheral internal edges which fit into peripheral grooves near the filter body ends and the filterhead end opposite the filter body. The connection between the filter bodies using connection elements -4- also comprises clamps -10-.

1. A system for filtering fluids, which comprises a plant formed by membrane filters, in which the fluid to be filtered is fed into the plant first with the flow in a certain direction and then fed into the same plant with the flow reversed.

2. A system for filtering fluids, according to claim 1, in which the plant comprises valves which regulate the fluid flow and which mix the flow which is fed into the plant from different points of same.

3. A system for filtering fluids, according to the above claims, in which the filters which make up the plant are directly connected to each other without the need for external piping.

4. A system for filtering fluids, according to claim 3, in which the filters are connected to each other via their filterhead ends.

5. A filter used in the system for filtering fluids, according to claim 1, in which its structure allows the reversal of the flow.
